(19) United States
(12) Patent Application Publication
(10) Pub. No.: US 2017/0042120 A1
(43) Pub. Date: Feb. 16, 2017

(54) Pet Cooling Assembly

(71) Applicant: Marc Cain, Fishers, IN (US)

(72) Inventor: Marc Cain, Fishers, IN (US)

(21) Appl. No.: 14/826,748

(22) Filed: Aug. 14, 2015

(51) Int. Cl. A01K 13/00

(52) U.S. Cl. CPC A01K 13/006

(57) ABSTRACT

A pet cooling assembly includes a cover that may be worn by an animal. A gel pack is removably positioned within the cover. The gel pack may be selectively refrigerated prior to the cover being worn by the animal. The gel pack is comprised of a thermally insulating material such that the gel pack may cool the animal while the animal wears the cover. A plurality of sets straps is provided and each of the sets of straps is coupled to the cover. Each of the sets of straps may engage the animal thereby retaining the cover on the animal.

### BACKGROUND OF THE DISCLOSURE

Field of the Disclosure

The disclosure relates to cooling devices and more particularly pertains to a new cooling device for selectively cooling an animal.

SUMMARY OF THE DISCLOSURE

An embodiment of the disclosure meets the needs presented above by generally comprising a cover that may be worn by an animal. A gel pack is removably positioned within the cover. The gel pack may be selectively refrigerated prior to the cover being worn by the animal. The gel pack is comprised of a thermally insulating material such that the gel pack may cool the animal while the animal wears the cover. A plurality of sets straps is provided and each of the sets of straps is coupled to the cover. Each of the sets of straps may engage the animal thereby retaining the cover on the animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a pet cooling assembly according to an embodiment of the disclosure.

FIG. 2 is a bottom view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DESCRIPTION OF THE PREFERRED EMBODIMENT

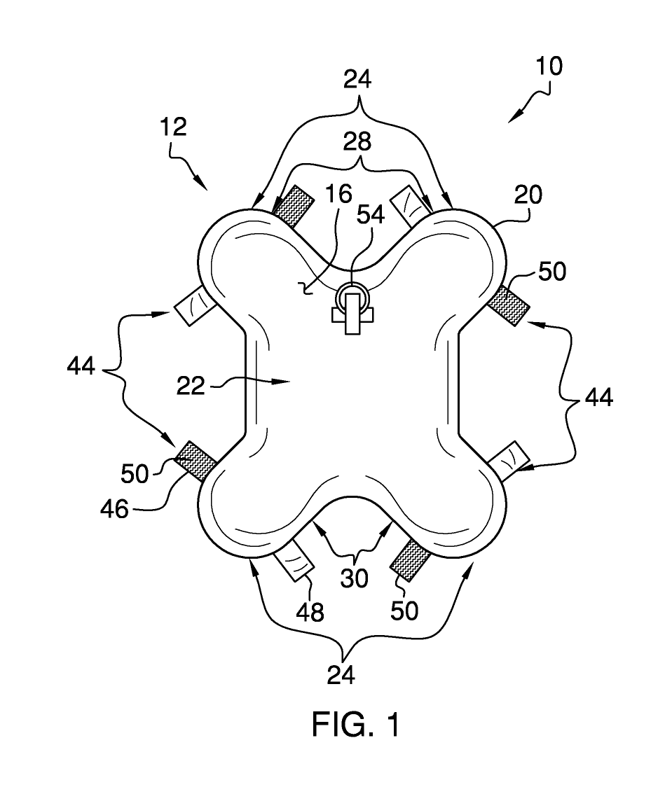

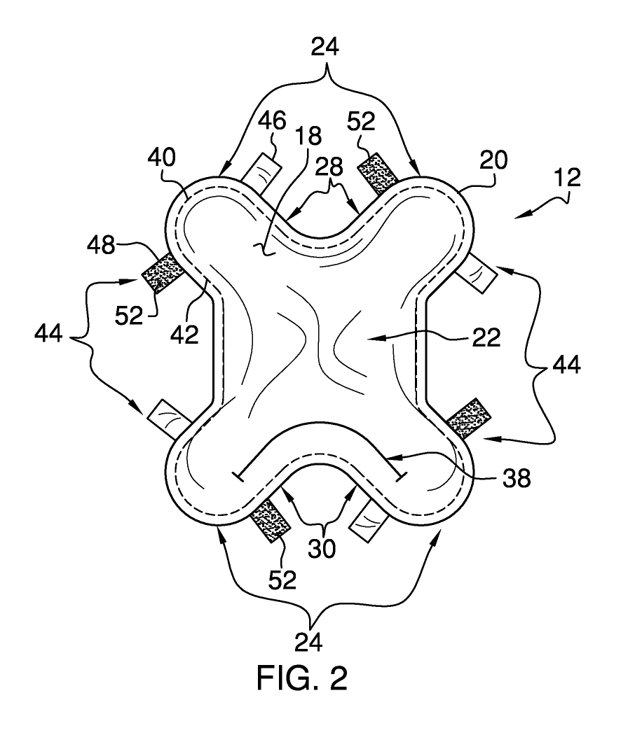

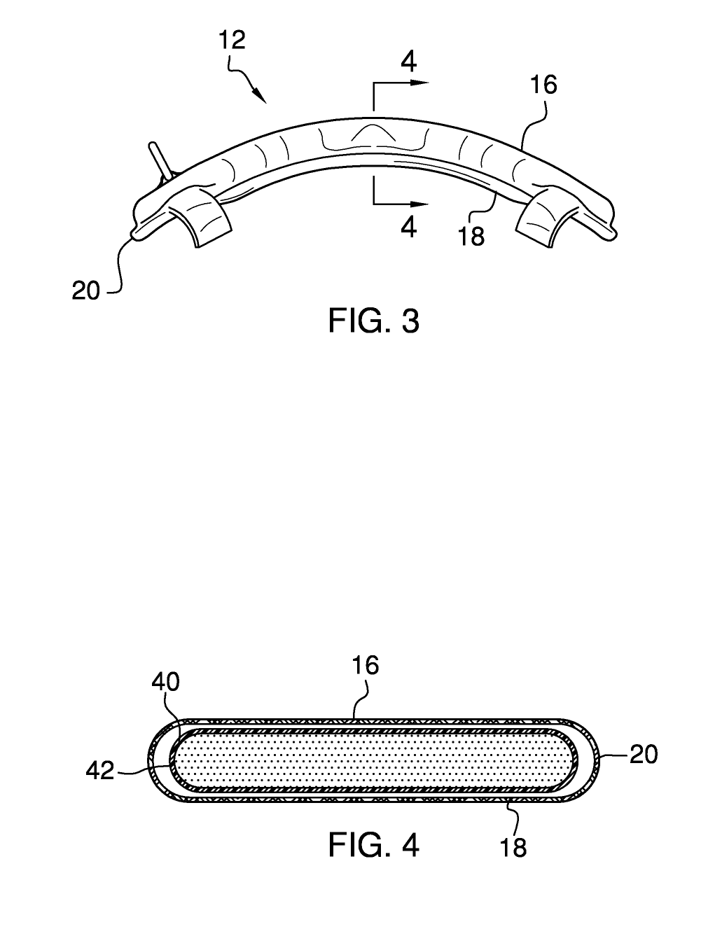

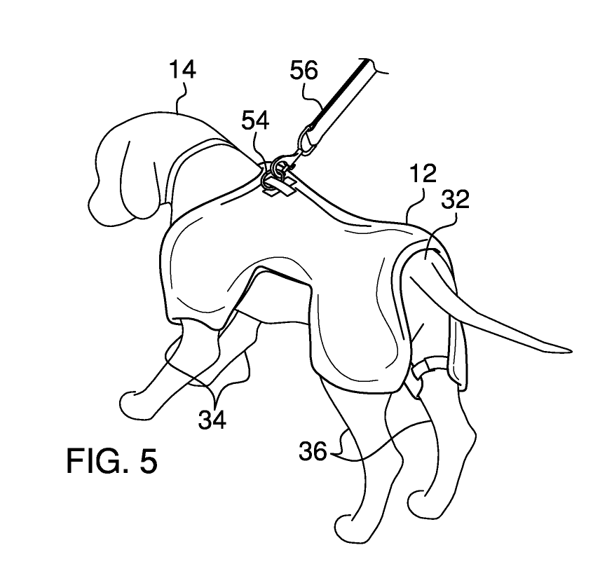

With reference now to the drawings, and in particular to FIGS. 1 through 5 thereof, a new cooling device embodying the principles and concepts of an embodiment of the disclosure and generally designated by the reference numeral 10 will be described.

As best illustrated in FIGS. 1 through 5, the pet cooling assembly 10 generally comprises a cover 12 that may be worn by an animal 14 and the animal 14 may be a dog or other domesticated animal. The cover 12 has a top surface 16, a bottom surface 18 and a peripheral edge 20 extending between the top surface 16 and the bottom surface 18. The peripheral edge 20 undulates along a length and a width of the cover 12 to define a body portion 22 and a plurality of lobes 24 extending away from the body portion 24. Each of the lobes 24 is aligned with an associated one of four corners 26 of the body portion 24.

The lobes 24 comprise a first set of lobes 28 and a second set of lobes 30. The first set of lobes 28 is spaced from the second set of lobes 30. The cover 12 may be positioned on the animal's back 32 having each of the first set of lobes 28 and the second set of lobes 30 being draped downwardly along each of an associated pair of front legs 34 and rear legs 36 of the animal 14. Thus, the cover 12 substantially covers the animal 14. The bottom surface 18 has a cut 38 extending therethrough to access an interior of the cover 12. The cut 38 is substantially coextensive with the second set of lobes 30.

A gel pack 40 is removably positioned within the cover 12 and the gel pack 40 may be selectively refrigerated or heated prior to the cover 12 being worn by the animal 14. The gel pack 40 is comprised of a thermally insulating material. Thus, the gel pack 40 may cool or warm the animal 14 while the animal wears the cover. The gel pack 40 may be filled with a non toxic material such as hydroxyethyl cellulose or the like.

The gel pack 40 is selectively insertable through the cut 38 such that the gel pack 40 is positioned between the top surface 16 and the bottom surface 18 of the cover 12. The gel pack 40 has an outer edge 42. The outer edge 42 is coextensive with the peripheral edge 20 of the cover when the gel pack 40 is positioned within the cover 12. The outer edge 42 is spaced inwardly from the peripheral edge 20.

A plurality of sets of straps 44 is provided and each of the sets of straps 44 is coupled to the cover 12. Each of the sets of straps 44 may engage the animal 14 thereby retaining the cover 12 on the animal 14. Each of the sets of straps 44 is positioned on the peripheral edge 20. Each of the sets of straps 44 is positioned on opposite sides of an associated one of the lobes 24 such that each of the sets of straps 44 may engage an associated one of the animal's front legs 34 and rear legs 36. Each of the set of straps 44 is complementary with respect to each other such that each of the set of straps 44 may retain the cover 12 on the animal 14.

Each of the sets of straps 44 includes a first strap 46 and a second strap 48. A plurality of first couplers 50 is provided and each of the first couplers 50 is coupled to the first strap 46 of an associated one of the sets of straps 44. A plurality of second couplers 52 is provided and each of the second couplers 52 is coupled to the second strap 48 of an associated one of the set of straps 44. Each of the first couplers 50 is complementary with respect to each of the second couplers 52. Each of the first 50 and second couplers 52 may comprise a hook and loop fastener or the like.

A ring 54 is coupled to the cover 12. The ring 54 may have a leash 56 attached thereto thereby facilitating the animal 14 to be restrained. The ring 54 is positioned on the top surface 16 and the ring 54 is positioned adjacent to the peripheral edge 20. The ring 54 is positioned between the first set of lobes 28 such that the ring 54 is positioned on the animal's back 32 when the cover 12 is worn by the animal 14.

In use, the gel pack 40 is either refrigerated or heated depending on whether the animal 14 is to be cooled or heated with the gel pack 40. The gel pack 40 is inserted through the cut 38 after the gel pack 40 has been refrigerated or heated. The cover 12 is positioned on the animal 14 and each of the set of straps 44 is coupled to the associated animal's front legs 34 and rear legs 36. Thus, the gel pack 40 cools or warms the animal 14 while the animal 14 wears the cover 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pet cooling assembly configured to selectively cool the pet in a hot environment, said assembly comprising:
a cover being configured to be worn by an animal;
a gel pack being removably positioned within said cover, said gel pack being configured to be selectively refrigerated prior to the cover being worn by the animal, said gel pack being comprised of a thermally insulating material wherein said gel pack is configured to cool the animal while the animal wears said cover; and
a plurality of sets straps, each of said sets of straps being coupled to said cover, each of said sets of straps being configured to engage the animal thereby retaining said cover on the animal.

2. The assembly according to claim 1, wherein said cover has a top surface, a bottom surface and a peripheral edge extending between said top surface and said bottom surface, said peripheral edge undulating along a length and a width of said cover to define a body portion and a plurality of lobes extending away from said body portion, each of said lobes being aligned with an associated one of four corners of said body portion.

3. The assembly according to claim 2, wherein said lobes comprise a first set of lobes and a second set of lobes, said first set of lobes being spaced from said second set of lobes, said cover being configured to be positioned on the animal's back having each of said first set of lobes and said second set of lobes being draped downwardly along each of an associated pair of front legs and rear legs of the animal such that said cover substantially covers the animal.

4. The assembly according to claim 3, wherein said bottom surface has a cut extending therethrough to access an interior of said cover, said cut being substantially coextensive with said second set of lobes.

5. The assembly according to claim 1, wherein:
said cover has a top surface, a bottom surface and a peripheral edge, said bottom surface having cut extending therethrough; and
said gel pack being selectively insertable through said cut such that said gel pack is positioned between said top surface and said bottom surface, said gel pack having an outer edge, said outer edge being coextensive with said peripheral edge of said cover when said gel pack is positioned within said cover, said outer edge being spaced inwardly from said peripheral edge.

6. The assembly according to claim 1, wherein:
said cover has a peripheral edge and a plurality of lobes; and
each of said sets of straps is positioned on said peripheral edge, each of said sets of straps being positioned on opposite sides of an associated one of said lobes wherein each of said sets of straps is configured to engage an associated one of the animal's legs, each of said set of straps being complementary with respect to each other such that each of said set of straps is configured to retain said cover on the animal.

7. The assembly according to claim 1, further comprising:
said cover having a top surface and a first set of lobes; and
a ring being coupled to said cover, said ring being configured to have a leash attached thereto thereby facilitating the animal to be restrained, said ring being positioned on said top surface, said ring being positioned between said first set of lobes wherein said ring is configured to be positioned on the animal's back when said cover is worn by the animal.

8. A pet cooling assembly configured to selectively cool the pet in a hot environment, said assembly comprising:
a cover being configured to be worn by an animal, said cover having a top surface, a bottom surface and a peripheral edge extending between said top surface and said bottom surface, said peripheral edge undulating along a length and a width of said cover to define a body portion and a plurality of lobes extending away from said body portion, each of said lobes being aligned with an associated one of four corners of said body portion, said lobes comprising a first set of lobes and a second set of lobes, said first set of lobes being spaced from said second set of lobes, said cover being configured to be positioned on the animal's back having each of said first set of lobes and said second set of lobes being draped downwardly along each of an associated pair of front legs and rear legs of the animal such that said cover substantially covers the animal, said bottom surface having a cut extending therethrough to access an interior of said cover, said cut being substantially coextensive with said second set of lobes;
a gel pack being removably positioned within said cover, said gel pack being configured to be selectively refrigerated prior to the cover being worn by the animal, said gel pack being comprised of a thermally insulating material wherein said gel pack is configured to cool the animal while the animal wears said cover, said gel pack being selectively insertable through said cut such that said gel pack is positioned between said top surface and said bottom surface, said gel pack having an outer edge, said outer edge being coextensive with said peripheral edge of said cover when said gel pack is positioned within said cover, said outer edge being spaced inwardly from said peripheral edge;
a plurality of sets straps, each of said sets of straps being coupled to said cover, each of said sets of straps being configured to engage the animal thereby retaining said cover on the animal, each of said sets of straps being positioned on said peripheral edge, each of said sets of straps being positioned on opposite sides of an associated one of said lobes wherein each of said sets of straps is configured to engage an associated one of the animal's legs, each of said set of straps being complementary with respect to each other such that each of said set of straps is configured to retain said cover on the animal; and
a ring being coupled to said cover, said ring being configured to have a leash attached thereto thereby facilitating the animal to be restrained, said ring being positioned on said top surface, said ring being positioned between said first set of lobes wherein said ring is configured to be positioned on the animal's back when said cover is worn by the animal.
